(19) United States
(12) Patent Application Publication
(10) Pub. No.: US 2018/0373209 A1
(43) Pub. Date: Dec. 27, 2018

(54) CONTROL SYSTEM, METHOD AND APPARATUS FOR UTILITY DELIVERY SUBSYSTEMS

(71) Applicant: NOID TECH, LLC, Phoenix, AZ (US)

(72) Inventors: Beau Henry RALPHS, Phoenix, AZ (US); Rodney Kenji NAKAMOTO, Phoenix, AZ (US); Seth Martin WINTERS, Phoenix, AZ (US); Peter Austin JOHNSON, Phoenix, AZ (US)

(21) Appl. No.: 16/063,560

(22) PCT Filed: Dec. 19, 2016
(86) PCT No.: PCT/US2016/067580

§ 371 Date: Jun. 18, 2018

Related U.S. Application Data
(60) Provisional application No. 62/269,791, filed on Dec. 18, 2015.
(60) Provisional application No. 62/286,854, filed on Jan. 25, 2016.

(51) Int. Cl. G05B 15/02; H04L 29/08; G06Q 50/06

(52) U.S. Cl. CPC G05B 15/02; G06Q 50/06; H04L 67/12

(57) ABSTRACT

A control subsystem, for a utility delivery subsystem having an effector for enabling or disabling delivery of a utility from a source to an output device via a conduit, includes an effector host configured to receive the effector at a port. The effector host operates the effector in response to an instruction received via a wireless communications interface. The subsystem includes a control gateway having a two communications interfaces, a first to establish a connection with the effector host, and a second to connect to a network. The control gateway includes a memory storing schedule data received via the second interface, and a processor configured to send the instruction to the effector host via the first interface, based on the schedule data. The subsystem includes a server having a memory storing the schedule data and a server communications interface for transmitting the schedule data to the control gateway.

### CROSS-REFERENCE TO RELATED APPLICATIONS

This application claims priority from U.S. provisional application No. 62/269,791, filed Dec. 18, 2015, and U.S. provisional application No. 62/286,854, filed Jan. 25, 2016. The contents of the above-mentioned applications are incorporated herein by reference.

### FIELD

The specification relates generally to utility (e.g. water, lighting) delivery subsystems, and specifically to a control system, method and apparatus for such subsystems.

### BACKGROUND

Various systems for the delivery of utilities (e.g. water for irrigation, electricity for lighting and the like) are deployed over areas such as golf courses, parks and the like. In addition to delivery infrastructure, such as pipes, valves and nozzles for irrigation systems, it is also necessary to deploy means to control the infrastructure. The control components for an irrigation system may include actuators for valves, sensors for soil moisture, rainfall and the like. The deployment of such control systems can require the installation of substantial lengths of cabling throughout the above-mentioned areas to deliver power and operational signals to the delivery systems. Further, portions of the control systems are generally required to be placed in close physical proximity to corresponding components of the mechanical systems, and thus are also distributed over large areas. These requirements render the deployment of new delivery and control equipment difficult and costly.

### SUMMARY

According to an aspect of the specification, a control subsystem is provided for a utility delivery subsystem having an effector for enabling or disabling delivery of a utility from a source to an output device via a conduit. The control subsystem includes: an effector host having an effector wireless communications interface and a port configured to receive the effector; the effector host configured to operate the effector via the port in response to an instruction received via the wireless communications interface; a control gateway having a first communications interface configured to establish a connection with the effector host, and a second communications interface configured to connect to a network; the control gateway further including a memory storing schedule data received via the second communications interface, and a processor configured to send the instruction to the effector host via the first communications interface, based on the schedule data; and a server having a memory storing the schedule data and a server communications interface for transmitting the schedule data to the control gateway.

### BRIEF DESCRIPTIONS OF THE DRAWINGS

Embodiments are described with reference to the following figures, in which:

FIG. 1 depicts a utility delivery and control system, according to a non-limiting embodiment;

FIG. 2 depicts certain internal components of an effector host and a sensor host of the system of FIG. 1, according to a non-limiting embodiment;

FIG. 3 depicts certain internal components of a control gateway and a server of the system of FIG. 1, according to a non-limiting embodiment;

FIG. 4 depicts a method of subsystem control, according to a non-limiting embodiment;

FIG. 5 depicts a method of generating and disseminating control data for a control subsystem, according to a non-limiting embodiment;

FIG. 6 depicts a control gateway, according to another non-limiting embodiment;

FIG. 7 depicts an effector host, according to another non-limiting embodiment;

FIGS. 8A-8B depict control daughter boards for the effector host of FIG. 7, according to another non-limiting embodiment;

FIG. 9 depicts a sensor host, according to a non-limiting embodiment; and

FIGS. 10 and 11 depict power sources for the components of the control subsystem, according to a non-limiting embodiment.

### DETAILED DESCRIPTION OF THE EMBODIMENTS

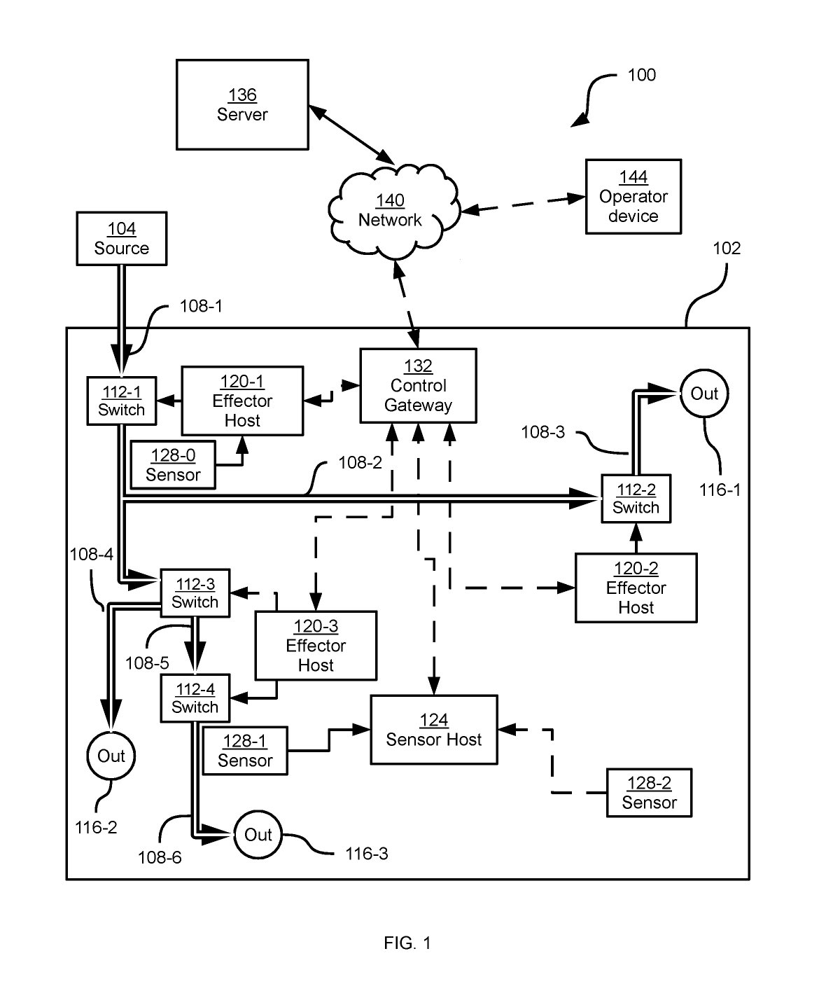

FIG. 1 depicts a system 100 comprising two subsystems, in the form of a utility delivery subsystem (also referred to herein as a delivery system) and a control subsystem (also referred to herein as a control system). The utility delivery subsystem, in general, includes a combination of devices and conduits for delivering a utility. The nature of the utility is not particularly limited, and can include materials such as water, as well as services such as lighting. In the present example, the delivery subsystem is configured to deliver water to a set of physical locations. More specifically, the delivery subsystem is an irrigation system configured to deliver water to a set of locations on a physical site or facility 102, such as a lawn, golf course, farm, park, or the like. In other examples, the delivery subsystem is a fire sprinkler system configured to deliver water to various locations within a facility (e.g. an office building) for fire suppression.

Accordingly, in the present example the utility delivery subsystem includes a utility source 104, such as a municipal water supply line. The utility delivery subsystem also includes a plurality of delivery conduits 108-1, 108-2, 108-3, 108-4, 108-5 and 108-6 (collectively referred to as conduits 108, and generically referred to as a conduit 108; this nomenclature is also used for other elements discussed herein). As will now be apparent, any suitable number and arrangement of conduits 108 can be deployed in the system 100. The conduits 108 include any suitable utility conduit, such as water pipes of any suitable construction.

The delivery subsystem also includes a plurality of switching devices (also referred to herein as switches) 112-1, 112-2, 112-3 and 112-4 (as with the conduits 108, any suitable number of switches 112 can be provided), such as valves. As will now be apparent, the switches 112 act to control the delivery of the utility via the conduits 108. Thus, in the example irrigation system, the switches 112 act to modulate the rate at which water flows through the corresponding conduits 108, from a null flow to a maximum flow. Further, the utility delivery subsystem includes a plurality of output devices 116-1, 116-2 and 116-3 (although any suitable number of output devices can be deployed), such as sprinkler nozzles, drip nozzles or the like. The output devices can also simply be perforations in distal segments of the conduits 108.

As will now be apparent, the delivery subsystem receives the utility (e.g. water) from the source 104, and conveys the utility to the outputs 116 via the conduits 108 and the switches 112. The control subsystem serves to control the components of the delivery subsystem to convey the utility as mentioned above. Accordingly, the control subsystem of the system 100 includes various devices and communications links to control the operation of the utility delivery subsystem. In the present example in which the utility delivery subsystem is configured to deliver water to the output devices 116, the control subsystem is configured to control the switching devices 112 to vary (including, at least, enabling and disabling) the flow of water to each of the output devices 116. Such control is, in the present example, implemented according to a predetermined schedule, to be discussed in greater detail below.

The control subsystem includes at least one effector host control device 120 (also referred to as an effector host). In the illustrated example, three effector hosts 120-1, 120-2 and 120-3 are included. The effector hosts 120 are each configured to connect to—and control the operation of—at least one switching device 112, via either wired (solid lines in FIG. 1) or wireless connections (dashed lines in FIG. 1). As will be discussed in greater detail below, at least some of the effector hosts 120 are configured to connect to a plurality of switches 112 (although not all available connections are required to be in use at any given time). For example, effector host 120-3 is illustrated as being connected to two switches, 112-3 and 112-4. Each effector host 120 is configured to monitor and transmit the current number of switches 112 under its control, and to receive and implement control instructions for those switches. Although the effector hosts 120 in FIG. 1 are all connected to valves, in other embodiments a variety of other types of effectors can also be controlled by corresponding types of effector hosts 120.

In addition to the effector hosts 120, the control subsystem includes at least one sensor host control device 124 (also referred to as a sensor host). The sensor host 124 is configured to connect to, and receive sensor data from, at least one sensor 128. In the present example, two sensors 128-1 and 128-2 are illustrated. Further, in the present example the sensor 128-1 is a flow sensor configured to monitor fluid flow through conduit 108-6 (i.e. the sensor 128-1 is associated with the switch 112-4), while the sensor 128-2 is a soil moisture sensor. Various other types of sensor 128 are also contemplated (such as motion sensors, light level sensors, temperature sensors and the like). The sensor host 124 is configured to monitor the types of sensors connected thereto, receive the data from such sensors, and transmit the sensor data for further processing at another element of system 100. In some examples, each sensor host 124 is configured to handle only a single sensor type. In such examples, the system illustrated in FIG. 1 would require two sensor hosts 124, one for each of the sensors 128 (which are of different types). Further, in some examples, the control subsystem can include sensors 128 that connect to effector hosts 120 rather than to sensor hosts 124. For example, as shown in FIG. 1, a sensor 128-0 in the form of a flow meter is placed to monitor flow immediately downstream of the switch 112-1 (i.e. flow along the conduit 108-1). The sensor 128-0 is configured to connect to the effector host 120-1 (via a wireless connection, such as Bluetooth) rather than to the sensor host 124.

In addition to the effector hosts 120, the sensor hosts 124 and the sensors 128, the control subsystem includes a control gateway 132. The control gateway 132 is typically located within site 102 or adjacent to site 102, as the control gateway 132 is configured to communicate via wireless links (e.g. WiFi, Bluetooth™, low power wide area networking technology such as LoRa, and the like) with the effector hosts 120 and sensor hosts 124. In particular, as will be discussed in greater detail below, the control gateway 132 (also referred to herein as a hub) stores control data such as utility delivery schedule data. Based on the control data, as well as sensor data received from the sensor host 124, the hub 132 generates and transmits instructions to the effector hosts for controlling the switches 112.

Further, the control subsystem includes a server 136 connected to the hub 132 via a network 140. The network 140 can include any of a variety of local (e.g. WiFi) and wide-area networks (e.g. mobile networks, the Internet and the like), including both wired and wireless networks. The server 136 is illustrated in FIG. 1 as being located off-site (i.e. not within the physical boundaries of site 102). However, in other embodiments, the server 136 can be located within the site 102.

The server 136, in general, is configured to store the above-mentioned control data for transmission to hub 132. As will be seen below, the server 136 is configured to generate the control data from transmission to the hub 132 based at least in part on commands received from an operator computing device 144 (e.g. a smartphone, personal computer or the like) connected to the network 140. The server 136 is also, in some examples, configured to generate the control data based on additional information retrieved from other data sources, typically in the form of other servers (not shown) connected to the network 140. Such servers can store weather data, sunset and sunrise data, and the like.

As will become apparent in the discussion below, control gateway 132, effector hosts 120, sensors hosts 124 and sensors 128 are specific to a given site 102 and a given delivery subsystem. Server 136, on the other hand, can store and transmit control data to a plurality of control subsystems, for use in controlling the operation of various corresponding delivery subsystems disposed at different sites. To that end, the server 136 is also configured, for each control subsystem (that is, for each site 102), to store identifiers of the components of the control subsystem and corresponding delivery subsystem, and to cooperate with the operator device 144 and the hub 132 at each site in order to facilitate the reconfiguration of the control and delivery subsystems as needed. Examples of reconfiguration include the addition or removal of a switch 112, the addition or removal of an effector host 120, and the like.

Before a more detailed discussion of the functions performed by the components of system 100, and particularly the functions performed by the control subsystem, certain internal components of the effector and sensor hosts 120 and 124, as well as the hub 132 and the server 136 will be discussed.

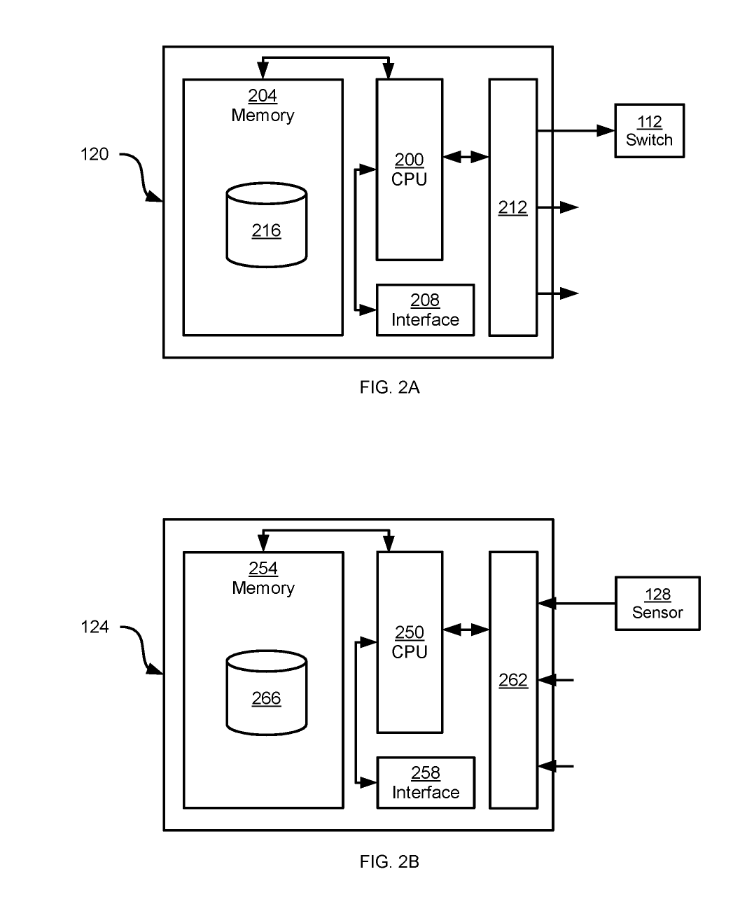

Turning to FIG. 2A, certain internal components of an effector host 120 are depicted. The components of the effector host 120 are typically housed in a substantially watertight enclosure (not shown), to protect the components from the elements at the deployed location within the site 102 of the effector host 120. The effector host 120 includes a central processing unit (CPU) 200, also referred to herein as a processor 200, interconnected with a memory 204. The memory 204 stores computer readable instructions executable by the processor 200 to configure the processor 200 to perform various functions discussed herein. The processor 200 and the memory 204 are generally comprised of one or more integrated circuits (ICs), and can have a variety of structures, as will now occur to those skilled in the art.

The effector host 120 also includes a communications interface 208 interconnected with the processor 200, which allows the effector host 120 to communicate with the hub 132, for example via a wireless link such as a Bluetooth™ Low Energy (BLE) link or a LoRa link. The communications interface 208 thus includes the necessary hardware, such as network interface controllers and the like, to communicate with the hub 132. Further, the effector host 120 includes an effector control interface 212 interconnecting the processor 200 with effectors. In the present example, the effectors are switches 112; the interface 212 therefore includes a plurality of physical connections (e.g. ports, slots for receiving circuit boards or the like), each configured to connect to one switch 112. The interface 212 can also establish wireless connections; thus, in some embodiments one or more ports can be provided by a transceiver (e.g. a Bluetooth transceiver). Three ports are illustrated, although it is contemplated that a variety of port configurations can be deployed. For example, as will be seen below, system 100 employs a combination of eight-port host effectors and single-port host effectors.

In the example of FIG. 2A, one of the three illustrated ports is currently active (i.e. connected with a switch 112), while another two ports are inactive. The interface 212 can therefore include any suitable combination of components for supplying power and control signals to switches 112. For example, when the switches 212 are solenoid-activated, the interface 212 can be configured to receive solenoid driver boards each configured to connect to and power a valve.

The effector host 120 also includes a power supply (not shown) for supplying electrical power to the above-mentioned components. The power supply can be any one of or combination of a variety of suitable power supplies, including batteries, solar panels and the like.

The memory 204 stores effector control data 216, including an identifier of the effector host 120 itself (typically preprogrammed at the time of manufacture, e.g. a MAC address or any other suitable identifier to distinguish the effector host 120 from the other components of the system 100). The control data 216 also includes a host type indicator. Further, the control data 216 includes, for each port of the interface 212, a status indicator (i.e. whether the port is active or inactive). Examples of effector control data 216 for effector hosts 120-1 and 120-3 are shown below in Tables 1 and 2.

TABLE 1
Example Effector Control Data - Effector Host 120-1

| Field | Value |
|---|---|
| Host ID | EH-120-1 |
| Host Type | Valve |
| Port 0 Status | Active |
| Port 1 Status | Active |
| Port 1 Type | Flow |

TABLE 2
Example Effector Control Data - Effector Host 120-3

| Field | Value |
|---|---|
| Host ID | EH-120-3 |
| Host Type | Valve |
| Port 0 Status | Active |
| Port 1 Status | Inactive |
| Port 2 Status | Inactive |
| Port 3 Status | Inactive |
| Port 4 Status | Active |
| Port 5 Status | Inactive |
| Port 6 Status | Inactive |
| Port 7 Status | Inactive |

The effector control data 216 of Table 1 indicates that the effector host 120-1 is a valve host with a single valve port and a single sensor port, which are both currently active (that is, the valve port has a solenoid driver or other wired or wireless valve actuator connected thereto; and the sensor port has the flow sensor 128-0 connected thereto). The effector control data of Table 2, meanwhile, indicates that the effector host 120-3 is a valve host with eight ports, two of which (corresponding to the switches 112-3 and 112-4 seen in FIG. 1) are currently active. Each effector host 120 is configured, upon startup, to assess the status of each port identified in the effector control data 216 in the memory 204, and to update the status values as needed. As a result, effectors (e.g. switches 112) can be added and removed by rebooting the corresponding effector host 120. In other examples, effectors may also be hot-swapped, negating the need to restart the effector host 120.

Referring now to FIG. 2B, certain internal components of a sensor host 124 are depicted. The components of the sensor host 124 are typically housed in a substantially watertight enclosure (not shown), to protect the components from the elements at the deployed location within the site 102 of the sensor host 124. The sensor host 124 includes a CPU 250, also referred to herein as a processor 250, interconnected with a memory 254. The memory 254 stores computer readable instructions executable by the processor 250 to configure the processor 250 to perform various functions discussed herein. The processor 250 and the memory 254 are generally comprised of one or more integrated circuits (ICs), and can have a variety of structures, as will now occur to those skilled in the art.

The sensor host 124 also includes a communications interface 258 interconnected with the processor 250, which allows the sensor host 124 to communicate with the hub 132, for example via a wireless link such as a BLE link or a LoRa link. The communications interface 258 thus includes the necessary hardware, such as network interface controllers and the like, to communicate with the hub 132. Further, the sensor host 124 includes a sensor control interface 262 interconnecting the processor 250 with sensors 128. In particular, the interface 262 includes a plurality of wired or wireless connections (e.g. ports, slots for receiving circuit boards or the like), each configured to connect to one sensor 128. As noted earlier in connection with the interface 212, the ports, as they are referred to below, may be physical connections or may permit the establishment of wireless connections via a transceiver. In the example of FIG. 2B, one port is currently active (i.e. connected with a sensor 128), while another two ports are inactive. The interface 262 can therefore include any suitable combination of components for supplying power to the sensors 128 and receiving sensor data from the sensors 128.

The sensor host 124 also includes a power supply (not shown) for supplying electrical power to the above-mentioned components. The power supply can be any one of or combination of a variety of suitable power supplies, including batteries, solar panels and the like.

The memory 254 stores sensor control data 266, including an identifier of the sensor host 124 itself (typically preprogrammed at the time of manufacture, e.g. a MAC address or any other suitable identifier to distinguish the sensor host 124 from the other components of the system 100). The control data 266 also includes a host type indicator, and for each port of the interface 262, a status indicator (i.e. whether the port is active or inactive) and a type indicator identifying the type of sensor connected to the port. The sensor type indicators can be provided by the sensors themselves. In other examples, each sensor host 124 is configured to handle only a single type of sensor; in such embodiments, the host type indicates the type of sensor, and the port-specific fields include only status indicators. Example sensor control data 266 for sensor host 124 is shown below in Table 3.

TABLE 3
Example Sensor Control Data - Sensor Host 124

| Field | Value |
|---|---|
| Host ID | SH-124 |
| Host Type | Sensor |
| Port 0 Status | Active |
| Port 0 Type | Flow |
| Port 1 Status | Active |
| Port 1 Type | Moisture |

As seen in Table 3, sensor host 124 is identified as a sensor host by the type indicator, and the port status data indicates not only whether or not each port is active, but also what type of sensor is connected to each port. Each sensor host 124 is configured, upon startup, to assess the status of each port identified in the sensor control data 266 in the memory 254, and to update the status and sensor type values as needed. As a result, sensors 128 can be added and removed by rebooting the corresponding sensor host 124. In other examples, sensors may also be hot-swapped, negating the need to restart the sensor host 124.

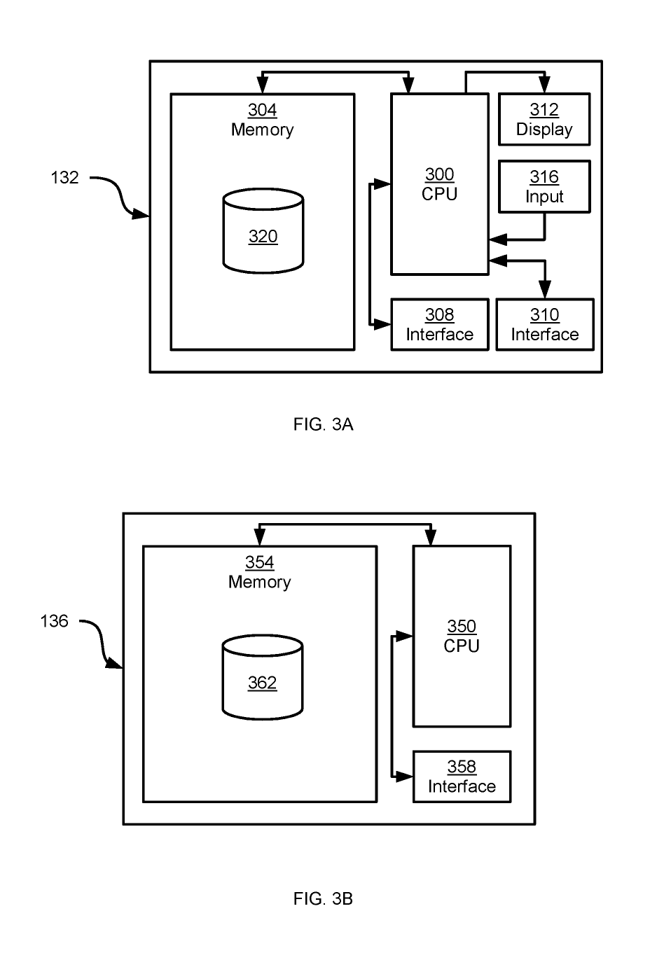

Turning now to FIG. 3A, certain internal components of a hub 132 are depicted. The components of the hub 132 are typically housed in a substantially watertight enclosure (not shown), to protect the components from the elements at the deployed location within the site 102 of the hub 132. As will be apparent to those skilled in the art, in the present example of an irrigation system, the effector and sensor hosts 120 and 124 are deployed in physical proximity to the corresponding portions of the water delivery subsystem, and are therefore exposed to wind, rain and the like. The hub 132 may be installed at a greater remove from the elements of the water delivery subsystem, but may still be deployed outdoors at the site 102 to ensure reliable communications are established between the hub 132 and the hosts 120 and 124.

The hub 132 includes a CPU 300, also referred to herein as a processor 300, interconnected with a memory 304. The memory 304 stores computer readable instructions executable by the processor 300 to configure the processor 300 to perform various functions discussed herein. The processor 300 and the memory 304 are generally comprised of one or more integrated circuits (ICs), and can have a variety of structures, as will now occur to those skilled in the art.

The hub 132 also includes a local communications interface 308 interconnected with the processor 300, which allows the hub 132 to communicate with the effector and sensor hosts 120 and 124, for example via a wireless link such as a BLE link or a LoRa link. The communications interface 308 thus includes the necessary hardware, such as network interface controllers and the like, to communicate with the hosts 120 and 124. The hub 132 also includes a remote communications interface 310 interconnected with the processor 300, which allows the hub 132 to communicate with the server 136 via the network 140. The interface 310 can be based on any suitable wireless or wired link, and therefore includes any necessary hardware (e.g. transceivers and the like) to implement such a link. In the present example, the interface 310 is configured to establish a connection with a mobile network (e.g. GSM, 3G or the like). In other examples, the interface 310 can enable, instead of or in addition to the above-mentioned mobile link, a WiFi link.

Further, the hub 132 includes a display 312 and an input device 316, such as a keypad, touch screen, button panel or the like. In other examples, display 312 and input device 316 can be omitted. The hub 132 also includes a power supply (not shown) for supplying electrical power to the above-mentioned components. The power supply can be any one of or combination of a variety of suitable power supplies, including batteries, solar panels and the like.

The memory 254 stores hub control data 320, including an identifier and type for the hub 132 itself. The control data 230 also includes control data corresponding to any effector hosts 120 and sensor hosts 124 to which the hub 132 has been configured to connect (as will be discussed in greater detail below). In the present example, the control data 320 also includes a preconfigured network address (e.g. a MAC address, IP address, domain or the like) of the server 136.

The control data corresponding to effector and sensor hosts 120 and 124 includes the above-mentioned host type, port status and (if applicable) port type fields. Further, the control data 320 includes schedule data for controlling the underlying utility delivery subsystem. An example of the portion of the control data 320 corresponding to effector and sensor hosts 120 and 124 is shown below in Table 4. As will be apparent to those skilled in the art, a wide variety of formats and data structures can be employed to store the control data 320; the tabular format shown below is simply for illustrative purposes.

TABLE 4
Example Hub Control Data

| Host ID | Host Type | Port/Status/Type | Schedule |
|---|---|---|---|
| EH-120-1 | Valve | 0/Active | 9:30pm- |
| | | | 1:30am |
| | | 1/Active/Flow | N/A |
| EH-120-3 | Valve | 0/Active | 10pm-1am |
| | | 1/Inactive | N/A |
| | | 2/Inactive | N/A |
| | | 3/Inactive | N/A |
| | | 4/Active | 10pm-1am |
| | | 5/Inactive | N/A |
| | | 6/Inactive | N/A |
| | | 7/Inactive | N/A |
| SH-124 | Sensor | 0/Active/Flow | N/A |
| | | 1/Active/ | N/A |
| | | Moisture | |

As seen in Table 4, the control data 320 includes the host types and port status and (where applicable) type data as stored in the memories 204 and 254 discussed in connection with the effector host 120 and the sensor host 124. In addition, the control data 320 includes schedule data for each active effector port. The hub 132 is configured to enable the corresponding switch 112 during the specified time periods. To enable a switch 112, the hub 320 is configured to send an instruction, via the interface 310, to the effector host 120 corresponding to the switch 112. The instruction specifies the port to be controlled, and an indication of whether to enable or disable the port (i.e. to turn the delivery of water on or off). The schedule data shown above is received at the hub 132 from the server 136, as will be discussed in greater detail below.

Turning now to FIG. 3B, certain internal components of server 136 are depicted. The server 136 includes a CPU 350, also referred to herein as a processor 350, interconnected with a memory 354. The memory 354 stores computer readable instructions executable by the processor 350 to configure the processor 350 to perform various functions discussed herein. The processor 350 and the memory 354 are generally comprised of one or more integrated circuits (ICs), and can have a variety of structures, as will now occur to those skilled in the art.

The server 136 also includes a communications interface 358 interconnected with the processor 350, which allows the server 136 to communicate with other computing devices, including the hub 132, via the network 140. The communications interface 358 thus includes the necessary hardware, such as network interface controllers and the like, to communicate over the network 140.

The server 136 also includes a power supply (not shown) for supplying electrical power to the above-mentioned components. The power supply can be any one of or combination of a variety of suitable power supplies; typically the server 136 is supplied from a source of mains electricity, although the power supply can also include any other suitable source, including batteries, solar panels and the like.

The memory 354 stores server control data 362. As will be seen below, the control data 362 includes the control data stored by the hosts 120 and 124 and the hub 132, as well as additional control data employed by the server 136 to control the operation of the hosts 120 and 124 and the hub 132. The control data 362 also includes an account identifier; the identifiers of the control subsystem elements (hubs 132, effector hosts 120 and sensor hosts 124) are stored in association with an account identifier; although a single account identifier is discussed herein, it is contemplated that the server 136 can store data for a plurality of distinct accounts (e.g. corresponding to distinct, separately operated sites 102). In the example below, the account identifier also identifies the operator device 144. In other examples, separate account and device identifiers can be stored in association with each other. Table 5 includes an example of the control data 362.

TABLE 5
Example Control Data 362

| | | Host | Host | Port/ | |
|---|---|---|---|---|---|
| Account | Hub ID/ | ID/ | Type/ | Status/ | |
| ID | Location | Location | Subtype | Type | Schedule |
| 144 | H132/ | EH-120-1/ | Valve/ | 0/Active | 9:30pm- |
| | [x, y] | [x, y] | Master | | 1:30am |
| | | | | 1/Active/ | N/A |
| | | | | Flow | |
| | | EH-120-3/ | Valve/ | 0/Active | 10pm-1am |
| | | [x, y] | Standard | | |
| | | | | 1/Inactive | N/A |
| | | | | 2/Inactive | N/A |
| | | | | 3/Inactive | N/A |
| | | | | 4/Active | 10pm-1am |
| | | | | 5/Inactive | N/A |
| | | | | 6/Inactive | N/A |
| | | | | 7/Inactive | N/A |
| | | SH-124/ | Sensor | 0/Active/ | N/A |
| | | [x, y] | | Flow | |
| | | | | 1/Active/ | N/A |
| | | | | Moisture | |

As seen above, the control data 362 includes the identifiers and types of the effector hosts discussed earlier (the effector host 120-2 is omitted for simplicity of illustration; in practice, the control data 362 includes identifier and type data for every host 120 and 124 in the control subsystem). The control data 362 also includes the port status and (where applicable) type data for the hosts 120 and 124 as discussed above, as well as the schedule data.

In addition, the control data 362 includes the locations of each hub 132 and host 120 and 124. The locations can be stored in a variety of manners, including as GPS coordinates, coordinates in a frame of reference specific to the site 102, and the like. Although not shown above, the control data 362 can also include locations for each individual port on the hosts 120 and 124. As will now be apparent, such locations indicate not the physical location of the ports themselves, but rather of the delivery subsystem components connected to the ports. More generally, the server 136 can store a graphical map of the site 102 with the locations of the conduits 108, switches 112 and output devices 116 indicated thereon. Locations for the ports can be specified within the control data 362 by storing coordinates from the map within the control data 362 for each port.

Further, the control data 362 includes a subtype value for the effector hosts 120. In the present example, two effector host subtypes are contemplated: a master effector host, and a standard effector host. In brief, a master effector host is an effector host 120 that is connected (via the interface 212) to a master switch 112 enabling or disabling the delivery of water from the source 104 into the site 102 (e.g. the switch 112-1 in FIG. 1). Thus, the effector host 120-1 in FIG. 1 is considered of the “master” type. A standard effector host, on the other hand, is an effector host 120 connected to switches 112 that control the flow of water (or any other utility) to distal conduits and output devices 116. Thus, for example, the effector hosts 120-2 and 120-3 in FIG. 1 are standard effector hosts. There need not be any structural differences between the subtypes of effector host. Rather, the subtype can be configured (and reconfigured as necessary) within the control data 362; the server 136 is then configured to update the schedule data and propagate the schedule data as necessary.

Having discussed the components of the major elements of the control subsystem, a description of the operation of those major components, and of the hub 132 and the server 136 in particular, will now be provided. In brief, the hub 132 is configured to monitor the status of the effector and sensor hosts 120 and 124 and report such status to the server 136. The hub 132 is also configured to receive schedule data from the server 136 and implement the schedule defined by the schedule data via the above-mentioned instructions to the effector hosts 120. The server 136, meanwhile, is configured to perform various functions related to account administration and communication with the operator device 144, generation of the schedule data and dissemination of the schedule data to the hub 132.

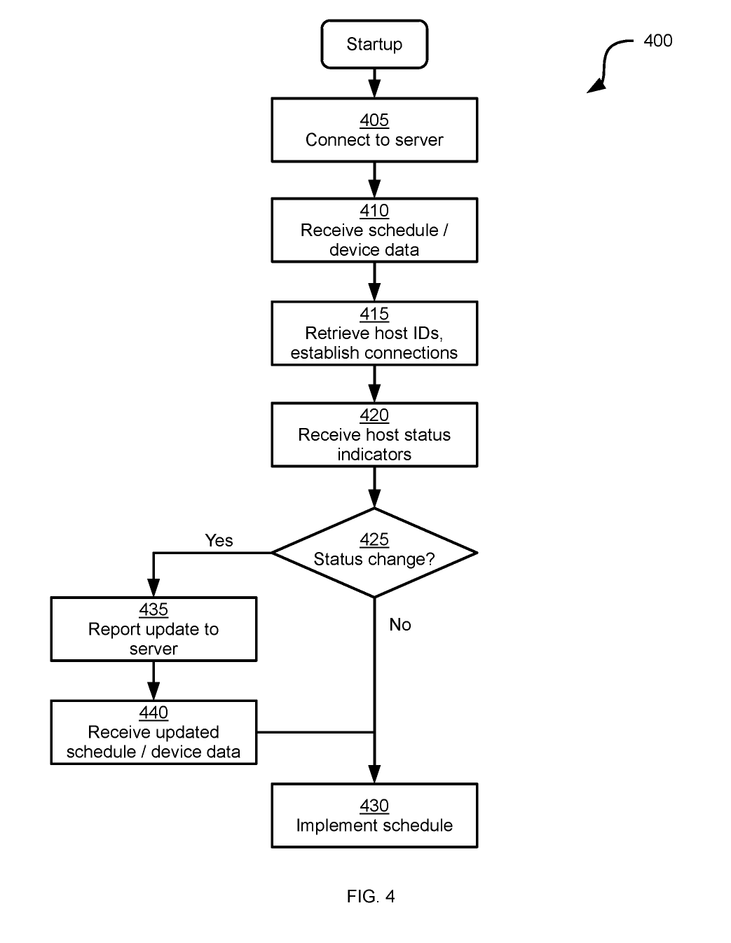

Turning to FIG. 4, a method 400 of local subsystem control is illustrated. The method 400 is performed by the hub 132, via the execution of computer-readable instructions stored in the memory 304. Following startup, at block 405 the hub 132 is configured to establish a communications link with the server 136. For example, the hub 132 is configured to retrieve the preconfigured network address of the server 136 from the memory 304, and transmit a connection request to the server 136. The hub 132 can be configured to present an error message on the display 312 if the attempt to establish a connection at block 405 fails. In some examples, the hub 132 can also be configured to transmit the error message to the operator device 144, e.g. via Bluetooth or any other suitable peer-to-peer communications link, when the operator device 144 is within range of the hub 132.

At block 410, the hub 132 is configured to receive, via the interface 308, and store in memory 304 schedule and device data from the server 136. More specifically, the hub 132 is configured to receive the control data shown in Table 4 from the server 136 (which stores that data as a subset of the control data 362). In general, the data received at block 410 informs the hub 132 of which devices the hub 132 is responsible for controlling (as a site 102 may include multiple hubs 132, and each host 120 or 124 is assigned to only one hub 132). The data received at block 410 also specifies the schedule according to which the hub 132 is required to control those devices.

At block 415, the hub 132 is configured to retrieve the host identifiers from the memory 304 and establish network connections with each of the identified hosts 120 and 124 via the interface 310. The nature of the connections and the specific processes to establish those connections will be apparent to those skilled in the art based on the communications protocol implemented by the interface 308 (e.g. BLE, LoRa). If any connections cannot be established (e.g. if the host effector 120-2 is identified in the control data 320 but cannot be reached via the interface 308), the hub 132 is configured to report to the server 136 (via the connection established at block 405) the identifier of the device for which no connection has been established. The server 136 can then be configured to transmit an alert to the operator device 144.

At block 420, having established connections with the devices identified in the control data 320, the hub 132 is configured to receive and store port status data from each of the connected devices. For example, the hub 132 can be configured to send a request to each of the hosts 120 and 124 for the status data stored in memory 204 and 254. The performance of block 420 can be repeated periodically during the operation of the hub 132.

At block 425, the hub 132 is configured to determine whether the port status data received at block 420 differs from the port status data received from the server 136 at block 410. When the determination at block 425 is negative, the performance of the method 400 proceeds to block 430, at which the hub 132 is configured to send operational commands to the effector hosts 120 based on the schedule data stored in the memory 304. It is also contemplated that during the performance of block 430, the hub 132 is configured to receive sensor data from the sensor host 124 and transmit the sensor data to the server 136. The hub 132 can also be configured to implement the schedule according to the sensor data. For example, more complex implementations of the schedule may specify that a given valve is to be enabled during a specified time period only if a threshold environmental condition is met (e.g. a temperature, soil moisture level, or the like).

As noted earlier, the operational instructions sent by the hub 132 to the effector hosts 120 during implementation of the schedule include the identifier of the relevant effector host 120, as well as the identifier of the relevant port to be enabled. The hub 132 can also be configured to listen for a confirmation message from the effector host 120 following each operational instruction. If no confirmation is received, or if the confirmation indicates that the effector host 120 has encountered an error (e.g. the solenoid driver connected to the specified port did not respond), the hub 132 can be configured to report the error condition to the server 136 for subsequent transmission to the operator device 144.

Returning to the determination at block 425, when the determination is affirmative, the hub instead proceeds to block 435. An affirmative determination at block 425 indicates that there are effectors (e.g. valves) or sensors connected to the hosts 120 and 124 that are not accounted for in the schedule data received at block 410. Alternatively, the affirmative determination may indicate that an effector or sensor for which the hub 132 does have control data is no longer present at site 102 (or has ceased to operate normally if present).

At block 435, the hub 132 is configured to transmit a message to the server 136 including an identifier of the affected host 120 or 124, and an identifier of the port for which the status data has changed. If the port is a port of a sensor host 124, the message can also include the type of sensor associated with that port. As will be discussed in greater detail below, the server 136 is configured, responsive to the above-mentioned message, to notify the operator device 144 of the change and obtain updated control data.

At block 440, the hub 132 is configured to receive updated schedule and device data from the server 136, to store the updated data in the memory 304 (i.e. to update the control data 320), and to then proceed to block 430. As will now be apparent, there may be a delay between the transmission of the message at block 435 and the receipt of the updated data at block 440. During that time, the hub 132 can be configured to perform block 430. That is, the hub 132 can be configured to implement the currently available schedule, ignoring effectors for which no schedule data is available.

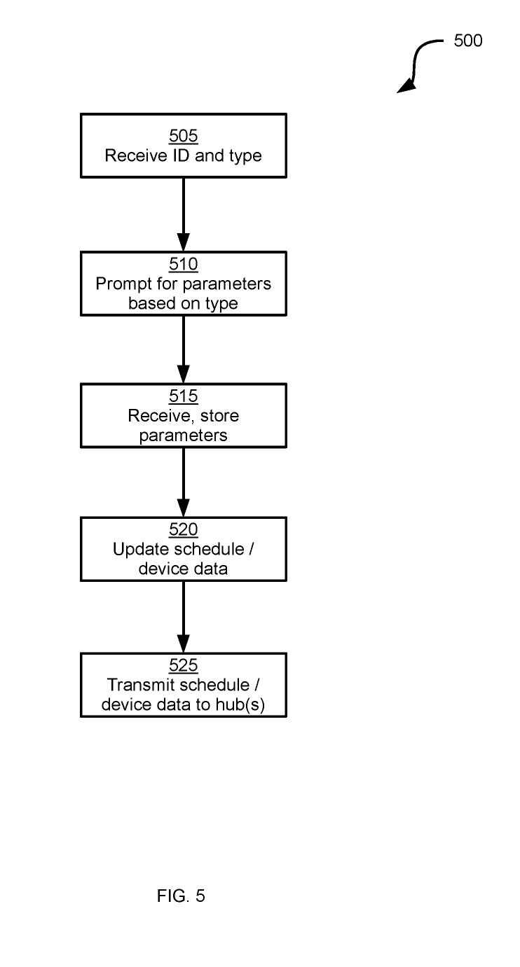

Turning now to FIG. 5, a method 500 of generating and disseminating control data for a control subsystem is depicted. The method 500 is performed by the server 136, via the execution (by the processor 350) of computer-readable instructions stored in the memory 354.

More specifically, the method 500 illustrates the actions taken by the server 136 to incorporate an additional device (e.g. an effector or sensor host 120 or 124, an individual effector or sensor, or even a hub 132) into a control subsystem, and to provide the relevant hub 132 with control data for the device. More generally, it will be appreciated in the discussion below that through the performance of method 500, the server 136 is enabled to ascertain the current population of devices in each control subsystem identified in the control data 362, and to prepare and disseminate schedule data for that current population.

At block 505, the server 136 is configured to receive, via the network 140 from the operator device 144, an identifier and a type of a device in a control subsystem. As mentioned above, the operator device 144 is associated with an account stored in the control data 362. If a request is received from an operator device that is not associated with an account, the server 136 is configured to prompt the operator device to create an account or authenticate with an existing account (e.g. by supplying a username and password) before continuing.

The identifier and type received at block 505 can be obtained by the operator device 144 in a variety of ways. For example, the operator device 144 can be configured to scan a graphical indicator, such as a QR code, imprinted on the device (such as an effector host 120) and decode the identifier and type from the captured graphical indicator. In other examples, the operator device 144 can receive the identifier and type via an input device such as a keyboard, or by connecting with the device via a peer-to-peer link (e.g. BLE) to obtain the identifier and type.

Responsive to receiving the identifier and type at block 505, the server 136 is configured to retrieve the account record corresponding to the operator device 144 for further processing. At block 510, the server 136 is configured prompt the operator device 144 for control parameters for the device identified at block 505, based on the type of the device. More specifically, the server 136 stores a list of device types (e.g. valve hosts, sensor hosts, hubs and the like) and corresponding lists of control parameters required for each device type. Therefore, the server 136 is configured to retrieve the list of control parameters corresponding to the type received at block 505, and to prompt the operator device 144 for values for those control parameters. Certain illustrative examples of the above-mentioned control parameters are discussed below.

For a hub 132, the control parameters include an assignment of host devices (i.e. the third column of Table 5); the server 136 is therefore configured to retrieve the identifiers of each host device in the control subsystem (regardless of the hubs to which they are currently assigned) and present those identifiers to the operator device 144 for selection. The control parameters for a hub also include a location (e.g. GPS coordinates, a selected location on a graphical representation of the site 102, and the like).

For a valve effector host 120, the control parameters include a subtype as described above (specifying whether the valve effector host is to be configured as a master valve controller or a standard valve controller), port status data indicating which ports on the interface 212 are active, and a location (e.g. GPS coordinates, a selected location on a graphical representation of the site 102, and the like). The server 136 is further configured to prompt the operator device 144 for additional control parameters when the “master” subtype is selected. The additional control parameters include selections of which standard effector hosts 120 control valves associated with the master valve (that is, valves connected to the master valve via conduits 108). As will now be apparent, a site 102 may have a plurality of master valves each admitting water to a distinct set of conduits 108. The server 136 may also prompt for selection of a flow meter (e.g. sensor 128-0) when the effector subtype is “master”.

For a sensor effector host 124, the control parameters include port status and sensor type indicators. The control parameters can also include a location (e.g. GPS coordinates, a selected location on a graphical representation of the site 102, and the like). Further, for flow sensor types, the control parameters can additionally include an identifier of a valve associated with the flow sensor. For example, referring to FIG. 1, the flow sensor 128-1 is shown as being immediately downstream of the switch 112-4. In other words, the flow sensor 128-1 measures the performance of the switch 112-4. Thus, the control parameters for the sensor host 124 can include, for the sensor 128-1, an identifier of the port of the effector host 120-3 to which the switch 112-4 is connected. The server 136 can be configured to prompt the operator device 144 to select from a list of currently configured effectors. In other examples, the server 136 can automatically select an effector having the same location as the relevant flow sensor. The server 136 can also be configured to prompt the operator device 144 for other sensor parameters, such as flow sensor model numbers, calibration coefficients, pipe diameters and the like.

Following the performance of block 510, at block 515 the server 136 is configured to receive and store control parameters from the operator device 144, via the network 140. That is, the server 136 is configured to populate the control data 362 (for example, as shown in Table 5) based on the selections and other data received from the operator device 144.

At block 520, the server 136 is configured to generate or update the schedule data for the control subsystem associated with the same account as the operator device 144. A wide variety of processes can be implemented by the server 136 to generate schedule data. In general, the server 136 is configured to select time periods of activity for at least a subset of the active ports of at least one effector host 120, and preferably for each active port of each effector host 120. The server 136 can also select sensor data thresholds associated with at least one of the effector ports (e.g. a soil moisture or temperature threshold). The time periods can be specified via input data transmitted to the server 136 from the operator device 144, or determined automatically by the server 136. Such automatic determinations can also be based on data retrieved by the server 136 from other sources (e.g. servers storing meteorological data, not shown in FIG. 1).

The server 136 can also be configured to generate the schedule data based on previous flow measurements, where available. For example, the server 136 can be configured (e.g. responsive to instructions from the operator device 144) to generate schedule data that enables effectors for sufficient time periods to deliver a predetermined target volume of water to the site 102, making use of the above-mentioned pipe diameters and historical measurements from flow sensors. As is evident from the example schedule data shown above, the any valves denoted as master valves are treated differently during schedule generation: the server 136 selects active time periods for any master valve that begin at least a configurable interval before the first standard valve downstream of the master valve is scheduled to open, and end at least a configurable interval (not necessarily the same configurable interval) before the last standard valve downstream is scheduled to close.

At block 525, the server 136 is configured to transmit the schedule data to the hub 132 (or multiple hubs 132, if there is more than one hub 132 associated with the site 102) for storage and implementation. As will now be apparent, when the identifier and type for a new hub 132 were received at block 505, the server 136 may not have a network address corresponding to the new hub. This may be remedied, for example, by the performance of block 405 as described above by the new hub. More specifically, every hub 132 may be configured to establish a connection with the server 132 (using the preconfigured network address of the server 136). When an unconfigured hub 132 (i.e. a hub 132 that has not yet been associated with an account) contacts the server 136, the server 136 can be configured to store the identifier and network address of the hub in the memory 354, but to take no further action with respect to that hub until a request associated with an account is received, as at block 505. Therefore, upon arriving at block 525, the server 136 can retrieve the network address of the hub from memory and employ that network address to transmit the schedule data.

The example performance of method 500 described above sets out the mechanism in system 100 for deploying a new host (120 or 124) or hub 132 on the site 102. It may also be desirable, however, to add new effectors or sensors to existing hosts. As noted earlier, each host 120 or 124 is configured, upon startup, to assess the status of the ports of the interfaces 212 or 262, respectively. When a change in the port status data is detected (e.g. a previously inactive port has become active), the host is configured to inform the hub 132 of the newly activated port. The hub 132, in turn, is configured to transmit a report to the server 136 including the identifier of the host 120 or 124 and an identifier of the activated port. The server 136 is configured to receive the above-mentioned report at block 505 (the type of the host device can be retrieved from the memory 362), and to then proceed through method 500 to configure the newly added effector or sensor.

The hub 132, the server 136 or both can also be configured to perform additional functions. For example, if the control subsystem includes a flow sensor, one or both of the hub 132 and the server 136 can be configured to assess valve performance during schedule implementation. For instance, the hub 132 can be configured to monitor flow data received from the sensor host 124 beginning a configurable interval after the corresponding valve (in the example of FIG. 1, switch 112-4) has opened, and for a configurable period of time. The average flow during the period of time can be compared to a target flow stored in memory, and if the average flow does not meet the target flow (indicating a leak in a conduit, incomplete opening of the valve, or the like), the hub 132 can report an error to the server 136, for transmission to the operator device 144. Flow measurements can also be monitored after all switches have been closed, to determine whether any switches have not properly closed.

Example implementations of certain components of the system 100 have been discussed above. Various other implementations are also contemplated, as will be discussed below.

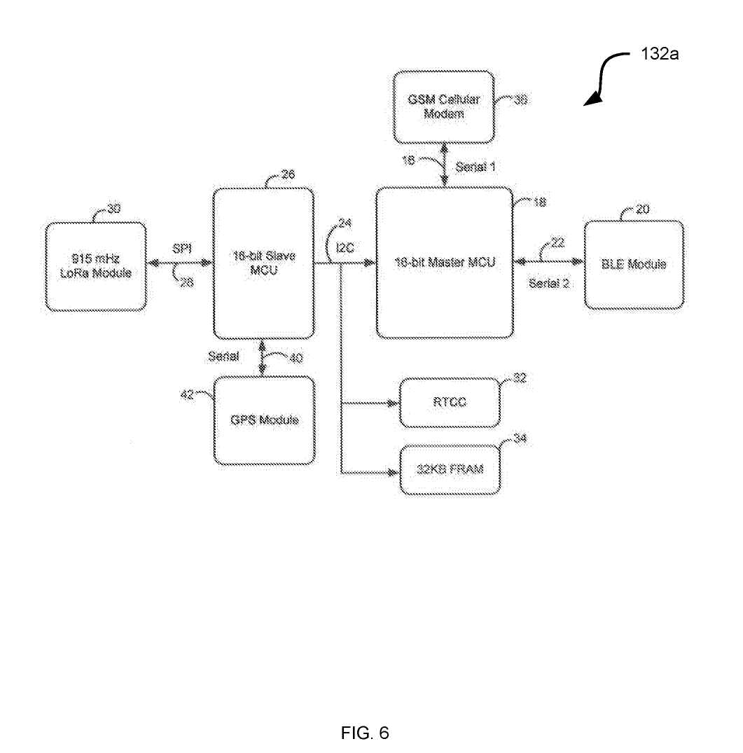

Turning to FIG. 6, a hub 132a is illustrated according to another example implementation. The processor of the hub 132a may include a master MCU 18. The master MCU 18 may comprise an event-driven firmware architecture configured to enable all attached peripherals to run asynchronously. For instance, in various embodiments, the master MCU 18 comprises a 16-bit Microchip PIC24HJ128GP204 microprocessor. In various embodiments, the master MCU 18 runs at 40 MIPS, although any microprocessor at any speed may be implemented to achieve any desired metric, such as sufficient I/O throughput, power consumption, and peripheral support.

The master MCU 18 may comprise serial buses 16 and 22. A serial bus 16, 22 may comprise a data communication bus configured to exchange data with a peripheral according to a serial data protocol. For instance, a cellular modem 36 may be in operative communication with the master MCU 18 via a serial bus 16. Moreover, a Bluetooth low energy (“BLE”) module 20 may be in operative communication with the master MCU 18 via a serial bus 22.

The cellular modem 36 may comprise a radio transceiver configured to communicate via cellular technology. In various embodiments, the cellular modem 36 comprises a bidirectional communication device configured to send data to the server 136 via the network 140, and receive data and commands therefrom. Moreover, the cellular modem 36 may receive commands via SMS messaging, which may override standing commands, may change parameters, and may perform internal maintenance tasks. In various embodiments, the cellular modem 36 comprises a FCC pre-certified modem, for instance a GL865-Quad modem available from Telit. The modem may interface to a contracted cellular network provider and communicate directly with the server 136, thus, in certain instances, at least a portion of the network 140 may comprise a cellular communications network.

The Bluetooth low energy module 20 may comprise a transceiver configured to send and receive data via Bluetooth radio technology. For instance, the Bluetooth low energy module 20 may enable the hub 132a to communicate with hosts 120, 124, or directly with user devices such as the operator device 144, or to detect the presence of proximate assets, such as golf carts having Bluetooth transponders. The Bluetooth low energy module 20 may be a FCC pre-certified module. For instance, the Bluetooth low energy module 20 may be available from Bluegiga and/or Silicon Labs. The module 20 may include an 8051 MCU and may be utilized as a scanner for all BLE modules broadcasting advertising packets. The Bluetooth low energy module 20 may receive commands from a compatible application running on a smart phone or other device, for instance, overriding current commands, changing parameters, and performing maintenance tasks. Moreover, the BLE module 20 may be used for initial configuration of the hub 132. For instance, in various instances, Wi-Fi credentials may be passed via the BLE module 20.

The master MCU 18 may comprise an I2C bus 24. An I2C bus comprises a communication bus operating according to the I2C protocol and configured to permit multiple slave devices to communicate with a master device on a shared bus. For instance, the I2C bus 24 may interconnect the master MCU 18, a slave MCU 26, a real-time clock and calendar (“RTCC”) 32, and a memory 34.

The RTCC 32 may comprise a real-time clock and calendar device. The RTCC 32 may provide the master MCU 18 with data representative of the time of day and date. The master MCU 18 may direct various communications with other aspects of the control subsystem in response to the passage of time.

The memory 34 may comprise an electronic data storage mechanism. In various embodiments, the memory 34 comprises a non-volatile ferro-electric random access memory device. The memory 34 may retain scheduling data and other variables that the master MCU 18 may access periodically. The memory may comprise 32 kilobytes of storage capacity, though any type and capacity may be chosen as desired.

The slave MCU 26 may connect to the master MCU 18 and may be configured to asynchronously manage various communication devices such as a LoRa module 30 and/or a GPS module 42 via its own SPI bus 28 and serial bus 40, respectively. The slave MCU 26 may appear to the master MCU 18 as an external memory unit, so that data coming in from the peripherals of the slave MCU 26 (such as the LoRa module 30 and/or GPS module 42) may be retrieved upon request by the master MCU 18. In various embodiments, the slave MCU 26 comprises firmware having event driven architecture, and may manage the LoRa module 30 and GPS module 42 independently of each other.

The slave MCU 26 may comprise serial bus 40. The serial bus 40 may comprise a data communication bus configured to exchange data with a peripheral according to a serial data protocol. For instance, GPS module 42 may be in operative communication with the slave MCU 26 via serial bus 40.

The GPS module 42 may comprise a global positioning system receiver. For instance, the GPS module 42 may comprise a Hornet Nano GPS available from OriginGPS. The GPS module 42 may provide location data to the slave MCU 26 whereby the positioning of different aspects of the system may be determined.

The slave MCU 26 may comprise a SPI bus 28. A SPI (Serial Protocol Interface) bus 28 may comprise a synchronous serial communication protocol configured to enable a single master device to communicate with one or more slave device via selection of various slave select lines. The master device configures the clock polarity and phase. As such, the devices on the bus advantageously do not necessitate synchronized clocks. In various embodiments, a LoRa module 30 connects to the slave MCU 26 via the SPI bus 28.

The LoRa module 30 may comprise a radio transceiver configured to communicate according to a LoRa protocol. For example, a Low Power Wide Area Network (LPWAN) specification may be implemented, such as LoRa WAN, available from the Lora Alliance of San Ramon, Calif. In various embodiments, the radio transceiver communicates via a RF center frequency of 915 MHz, although any selected frequency, bandwidth, modulation, and protocol may be implemented as desired. In some examples, either or both of the slave MCU 26 and the GPS module may be omitted. Further, one of the LoRa module 30 and the BLE module 20 may be omitted.

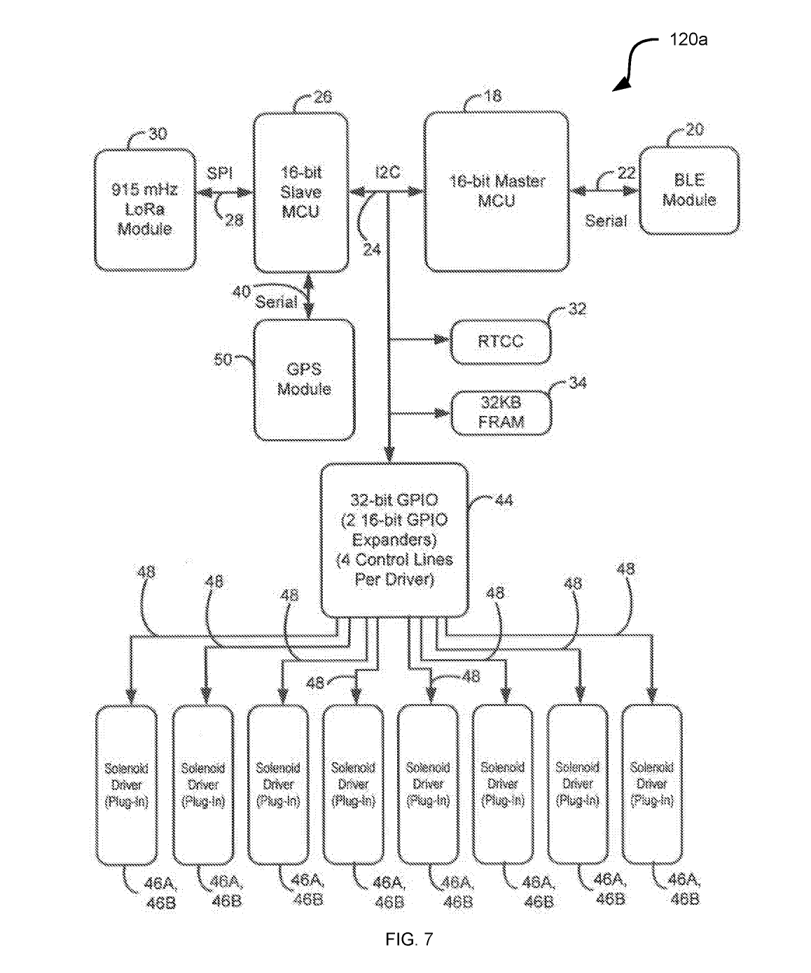

Turning to FIG. 7, an effector host 120a is illustrated according to another example implementation. The effector host 120a includes a master MCU 18, BLE module 20, slave MCU 26, LoRa module 30, GPS module 50, RTCC 32, and FRAM 34 substantially as discussed above. In addition, the effector host 120a includes, as an example implementation of the interface 212, a general-purpose input output controller (“GPIO”) 44. For example, a GPIO controller 44 may be in operative communication with the 12C bus 24 and may be configured to allow the master MCU 18 to control valves and other devices, such as via one or more solenoid driver 46A, 46B, connected via a plug-in control line sub-bus 48. For example, the GPIO controller 44 may comprise two 16-bit GPIO expanders. Thus, in various embodiments, each plug-in control line sub-bus 48 may comprise four control lines. In various embodiments, the effector host 120a, thus achieves control of eight peripheral solenoid drivers 46A, 46B or other devices. In various embodiments, the effector host 120a achieves control of such solenoid drivers 46A, 46B while also achieving efficient power consumption by actuating solenoid drivers 46A, 46B sequentially rather than simultaneously. For example, the master MCU 18 may actuate multiple valves controlled by solenoid drivers 46A, 46B to turn on or off multiple irrigation circuits. The master MCU 18 may direct the GPIO controller 44 to sequentially trigger the solenoid drivers 46A, 46B. In this manner, the instantaneous current draw is reduced compared to the instantaneous current draw otherwise associated with simultaneous actuation of multiple solenoid drivers 46A, 46B.

The solenoid driver 46A, 46B comprises a plug—in daughter board installable to the effector host 120a. The solenoid driver 46A, 46B is configured to provide control of power to latching solenoids that trigger valves. Thus, as noted earlier the effector host 120a may be reconfigurable by adding or removing solenoid driver 46A, 46B from receptacle slots disposed in the effector host 120a and configured to receive the plug-in daughter board.

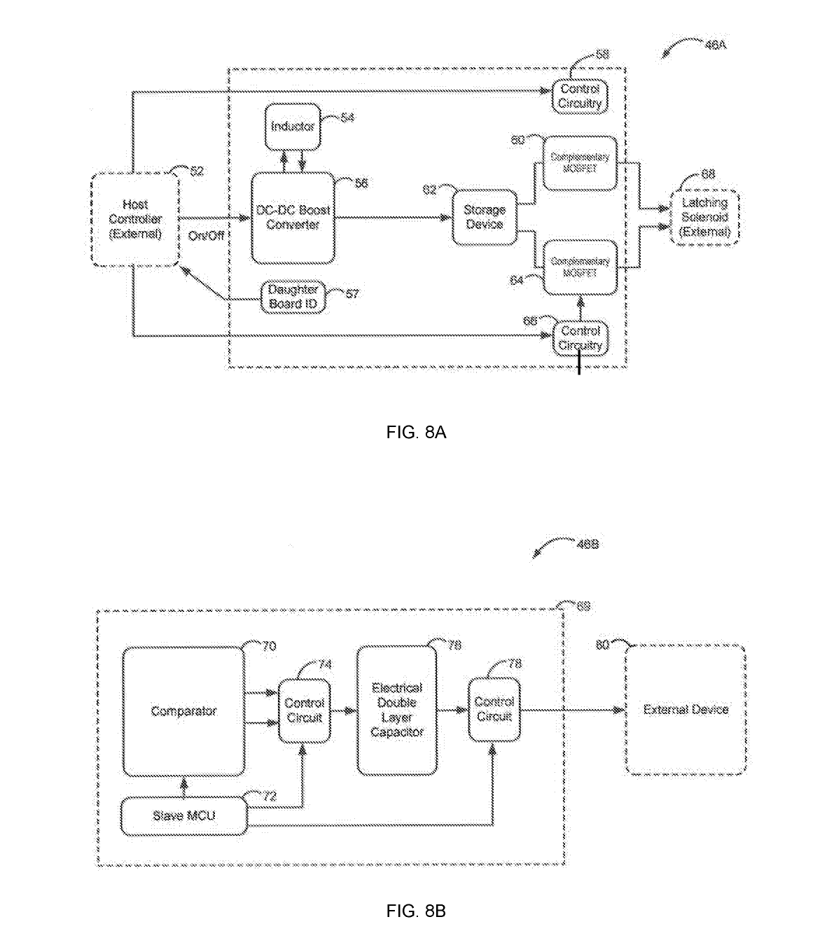

Further discussion of the daughter boards is provided below with reference to FIG. 8A. A host controller 52 may comprise a logical process running within an effector host 120 or 120a. The host controller 52 may power up the solenoid driver 46A with a nominal operating voltage of 3.3 VDC in order to drive a latching solenoid 68 from between different latched positions, and thus move a valve from different positions. To transition the latching solenoid 68 between positions, the solenoid driver 46A receive a nominal circuit voltage of 3.3 VDC from the host controller 52, and boosts the voltage to 25 VDC via a DC-DC boost converter 56. The DC-DC boost converter 56 may be in electrical communication with an inductor 54. The inductor 54 boosts the flow of electrons that enter one end of the coil. The inductor 54 normally resists electron flow until it builds up a sufficient magnetic field. Once the field is built the electrons flows freely until the field collapses and the electrons once again stop flowing. Thus, the DC-DC boost converter 56 in combination with the inductor 54 rapidly switches the voltage/current on and off (oscillation) to maintain the cycle of rebuilding/collapsing the magnetic field to maintain the flow of electrons and having the effect of boosting the voltage/current.

The DC-DC boost converter 56 may charge a storage device 62. The storage device 62 may integrate charge over time, for instance, permitting a lesser current over time, to accumulate charge so that loads drawing higher current may be actuated. For instance, the storage device 62 may comprise a capacitor. Following the charging of the storage device 62, the host controller 52 may direct a first control circuit 58 to drive a first MOSFET 60 and second control circuit 66 to drive a second MOSFET 64. The first MOSFET 60 and the second MOSFET 64 may then connect the storage device 62 to the latching solenoid 68, releasing the stored charge and causing the latching solenoid 68 to transition between positions.

Finally, the solenoid driver 46A may comprise a daughter board ID memory 57. The daughter board ID memory 57 may comprise a non-volatile storage memory in which a unique number is stored. The unique number may identify the solenoid driver 46A so that the host controller 52 of the effector host 120, 120a may distinguish among multiple connected solenoid drivers 46A.

FIG. 8B illustrates another example daughter board, configured to drive high loads (for instance, greater than 5 Amps at 25 VDC. In various embodiments, such solenoid driver 46B may include an electrical double layer capacitor (“EDLC”) 76, whereby a current may be provided, such as a greater current than provided by storage device 62 of solenoid driver 46A. The slave MCU 72 may manage a voltage comparator 70, which detects when the voltage is less than target voltage. When that occurs the slave MCU 72 turns on the first MOSFET switch (control circuit 74) to charge an EDLC 76 to the target voltage. When the EDLC 76 is fully charged the comparator 70 signals the slave MCU 72 to shut off the first MOSFET switch (control circuit 74). When a request is made to the slave MCU 72 to release the energy stored in the EDLC 76, the slave MCU 72 responds by turning on the second MOSFET switch (control circuit 78), releasing all of its stored energy—which is the target voltage at the demand current. The current can be significantly larger than what is normally available in the nominal circuit. For a few milliseconds, the current can be as much as 5 to 50 times higher (or more) because of the rapid release of energy from the EDLC 76. The voltage is throttled to the voltage rating of the EDLC 76 but the current can be much higher during the substantially instantaneous release of energy.

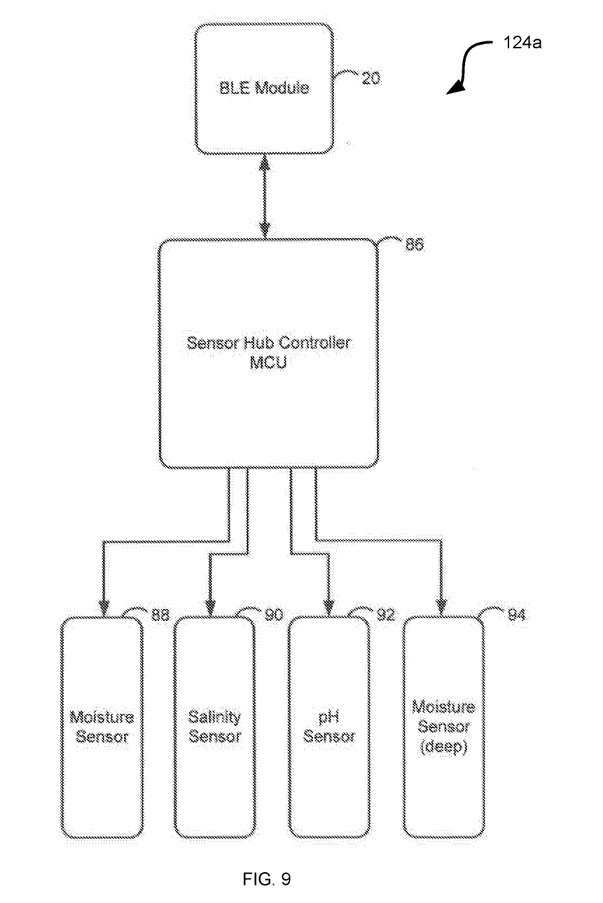

Referring now to FIG. 9, a sensor host 124a is illustrate according to another example implementation. The sensor host 124a includes a Bluetooth low energy module 20, as discussed earlier, as well as a sensor hub controller 86. The sensor hub controller 86 may comprise a microprocessor. For example, the microprocessor may comprise an event-driven firmware architecture configured to enable all attached peripherals to run asynchronously. For instance, in various embodiments, the microprocessor comprises a 16-bit Microchip PIC24HJ128GP204 microprocessor. In various embodiments, the microprocessor runs at 40 MIPS, although any microprocessor at any speed may be implemented to achieve any desired metric, such as sufficient I/O throughput, power consumption, and peripheral support. The sensor host 124a may also have one or more sensing element in operative communication with the sensor hub controller 86 and configured to determine an environmental variable. For instance, the NOID sensor 8 may include a shallow depth moisture sensor 88, a salinity sensor 90, a pH sensor 92, and/or a deep moisture sensor 94.

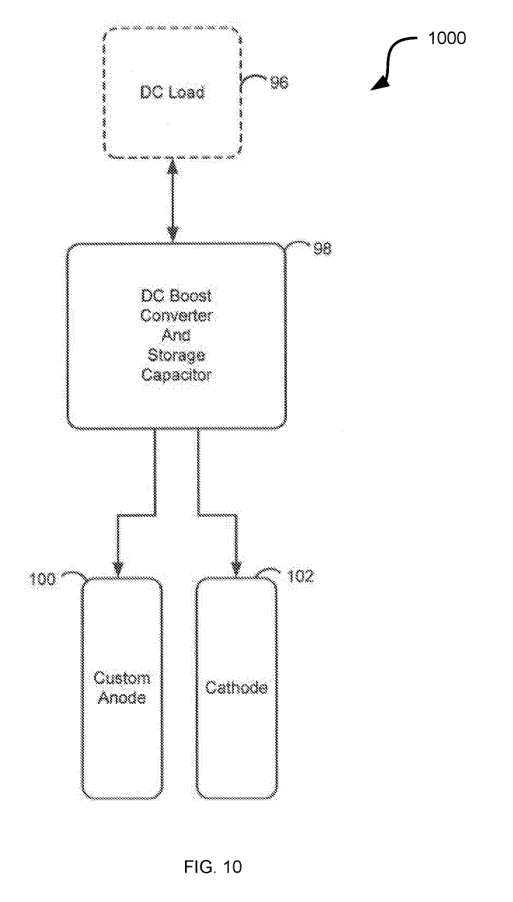

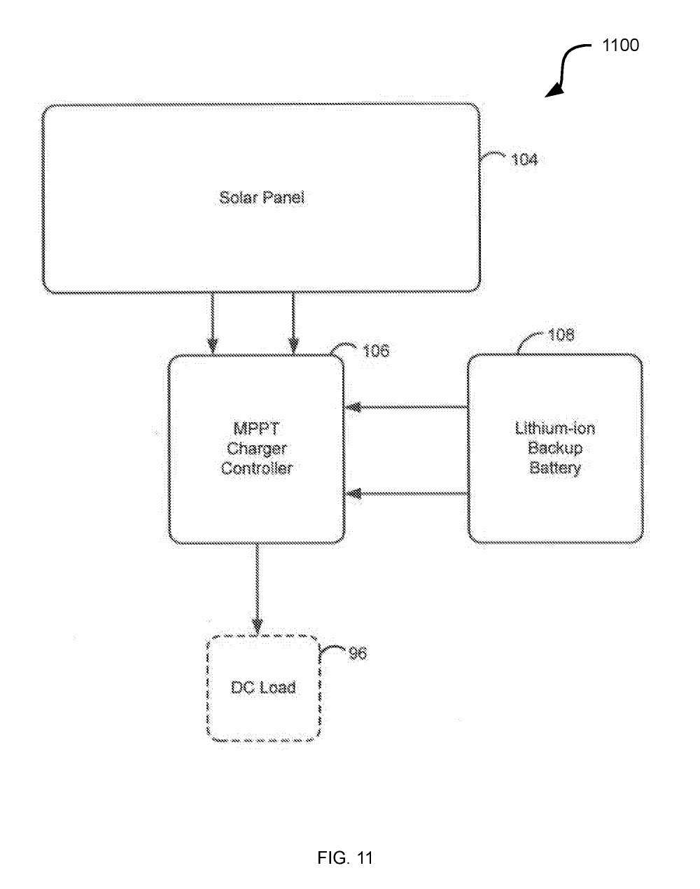

With reference to FIGS. 10 and 11, power supplies 1000 and 1100 are depicted, which may be employed to power any of the components on site 102 (depicted in FIGS. 10 and 11 as a DC load 96). For example, with reference to FIG. 10 the power supply 1000 may comprise a DC boost converter and storage capacitor 98. The DC boost converter and storage capacitor 98 may receive electrical power and boost the voltage of the power, and may further store the power so that it may be consumed by the DC load 96. The DC boost converter and storage capacitor 98 may receive the electrical power from a pair of electrodes. For instance, a cathode 102 and an anode 100 may be disposed in the soil proximate to the power supply 1000. The cathode 102 and the anode 100 may, along with the soil, form a circuit whereby a difference in electrical potential is developed across the cathode 102 and anode 100. The difference in electrical potential may cause an electrical current to flow into the DC boost converter and storage capacitor 98 for storage, conditioning (e.g., boosting the voltage), and provision to the DC load 96.

For further example, with reference to FIG. 11, the power supply 1100 may comprise a solar panel 104. The solar panel 104 may generate a difference in electrical potential in response to exposure to sunlight. The solar panel 104 may be connected to a charge controller 106. The charge controller 106 may receive an electrical current from the solar panel 104 and control the charging of a lithium ion backup battery 108, as well as control the delivery of the electrical current to DC load 96.

Further variations to the embodiments discussed above are contemplated. For example, in some embodiments, the hub 132 and the server 136 can be implemented as a single computing device. In further embodiments, the hub 132, server 136 and operator device 144 can be implemented as a single computing device.

The scope of the claims should not be limited by the embodiments set forth in the above examples, but should be given the broadest interpretation consistent with the description as a whole.

1. A control subsystem for a utility delivery subsystem having an effector for enabling or disabling delivery of a utility from a source to an output device via a conduit; the control subsystem comprising:
an effector host having an effector wireless communications interface and a port configured to receive the effector; the effector host configured to operate the effector via the port in response to an instruction received via the wireless communications interface;
a control gateway having a first communications interface configured to establish a connection with the effector host, and a second communications interface configured to connect to a network; the control gateway further including a memory storing schedule data received via the second communications interface, and a processor configured to send the instruction to the effector host via the first communications interface, based on the schedule data; and
a server having a memory storing the schedule data and a server communications interface for transmitting the schedule data to the control gateway.

2. The control subsystem of claim 1, further comprising:
a sensor host having a sensor wireless communications interface and a port configured to receive a sensor; the sensor host configured to receive sensor data via the port and to transmit the sensor data via the sensor wireless communications interface.

3. The control subsystem of claim 2, the sensor host configured to transmit the sensor data to one of the control gateway and the effector host via the sensor wireless communications interface.

4. The control subsystem of claim 1, the effector host having a plurality of ports each configured to receive one of a plurality of effectors; the effector host further configured to:
monitor the status of each of the ports;
store, in a memory, status data including an indication for each port of whether the port is active or inactive; and
transmit the status data to the control gateway.

5. The control subsystem of claim 4, the control gateway further configured to:
compare the status data to the schedule data;
when the status data does not match the schedule data, send the status data to the server.

6. The control subsystem of claim 5, the server further configured to:
receive the status data; and
prompt an operator computing device for configuration data corresponding to the effectors identified in the status data.

7. The control subsystem of claim 1, the server further configured to:
receive an identifier and a device type from an operator computing device via a network, the identifier and device type corresponding to a further effector host;
retrieve a set of configuration parameters from the memory;
prompt the operator computing device for values corresponding to the configuration parameters; and
update the schedule data based on the values.

8. The control subsystem of claim 1, further comprising:
a sensor connected to the effector host; the effector host further configured to receive sensor data from the sensor and to relay the sensor data to the control gateway.

9. A method of controlling a utility delivery subsystem having an effector for enabling or disabling delivery of a utility from a source to an output device via a conduit; the method comprising:
storing, in a memory of a server, schedule data for controlling the utility delivery subsystem;
at a first communications interface of a control gateway, establishing a connection with the server and receiving the schedule data from the server;
storing the schedule data at the control gateway;
at a second communications interface of the control gateway, establishing a connection with an effector host having a port configured to receive the effector; and
transmitting an instruction to the effector host based on the schedule data;
at the effector host, operating the effector via the port in response to the instruction.

10. The method of claim 9, further comprising:
at a sensor host:
receiving sensor data from a sensor; and
transmitting the sensor data to the control gateway via the connection.

11. The method of claim 10, wherein transmitting the sensor data comprises:
establishing a connection with the second communications interface of the control gateway; and
transmitting the sensor data via the connection.

12. The method of claim 10, wherein transmitting the sensor data comprises:
establishing a connection with the effector host; and
transmitting the sensor data via the connection.

13. The method of claim 12, further comprising:
receiving the sensor data at the effector host; and
transmitting the sensor data from the effector host to the control gateway.

14. The method of claim 9, further comprising, at the effector host:
receiving one of a plurality of effectors at each of a plurality of effectors;
monitoring the status of each of the ports;
storing, in a memory, status data including an indication for each port of whether the port is active or inactive; and
transmitting the status data to the control gateway.

15. The method of claim 14, further comprising, at the control gateway:
comparing the status data to the schedule data; and
when the status data does not match the schedule data, sending the status data to the server.

16. The method of claim 15, further comprising, at the server:
receiving the status data; and
prompting an operator computing device for configuration data corresponding to the effectors identified in the status data.

17. The method of claim 9, further comprising, at the server:
receiving an identifier and a device type from an operator computing device via a network, the identifier and device type corresponding to a further effector host;
retrieving a set of configuration parameters from the memory;
prompting the operator computing device for values corresponding to the configuration parameters; and
updating the schedule data based on the values.

18. The method of claim 9, further comprising, at the effector host:
receiving sensor data from a sensor connected to the effector host; and
relaying the sensor data to the control gateway.
